(19) United States
(12) Patent Application Publication
(10) Pub. No.: US 2015/0042675 A1
(43) Pub. Date: Feb. 12, 2015

(54) Pattern Based Design Application

(71) Applicant: Denise M. Burke, Southborough, MA (US)

(72) Inventor: Denise M. Burke, Southborough, MA (US)

(21) Appl. No.: 14/049,378

(22) Filed: Oct. 9, 2013

Related U.S. Application Data
(60) Provisional application No. 61/862,749, filed on Aug. 6, 2013.

(51) Int. Cl. G06F 3/0484; G06F 3/0482; G06T 11/60

(52) U.S. Cl. CPC G06F 3/04845; G06T 11/60; G06F 3/04842; G06F 3/0482; G06T 2200/24
USPC 345/629

(57) ABSTRACT

A pattern based design tool includes a plurality of image building functions for generating visual content on an on-screen rendered area, or canvas, in which the canvas is responsive to graphical manipulations for changing the appearance of an image on the canvas. A plurality of available image building functions and image manipulation functions allow modification of the visual content on the canvas to generate a modified image, such that the canvas accumulates visual content in response to the functions. The accumulated image on the canvas is incorporated as a repeated pattern in successive drawing functions, such that the accumulated image defines a repeated portion of the successively applied drawing functions, and represents a hierarchy of previously entered images to define a sub pattern of entered items on the canvas. In this manner, a repeated pattern defines a sub-element of a drawing function.

### RELATED APPLICATIONS

This patent application claims the benefit under 35 U.S.C. §119(e) of U.S. Provisional Patent App. No. 61/862,749, filed Aug. 6, 2013, entitled “PATTERN BASED DESIGN APPLICATION,” incorporated herein by reference in entirety.

### BACKGROUND

Conventional graphic designs for various display mediums typically require substantial time and artistic ability. Such designs are employed in a variety of contexts, often for a hardcopy or physical medium such as paper or fabric, including clothing, advertising and brand designation, scrapbooks, greeting cards, and other contexts where a visually pleasing aesthetic appearance is desired. In recent decades, inexpensive computer hardware has enabled graphical design to deviate from conventional paper mediums. Electronic renderings of graphical images may be developed on a visual display using drawing tools, rather than conventional ink or paint, and saved in a digital (electronic) format for subsequent recall and editing. Digital based designs may be electronically altered on the visual display, and modified or transformed more dynamically than conventional paper or hardcopy mediums, which are typically difficult or impossible to change or modify once image items are rendered. A graphical user interface (GUI) provides drawing tools for a user/artist to enter items of an image, similar to a pen or brush in conventional mediums, but allows saving, erasure and modification of the items in the on-screen rendered image. Upon completion, the on-screen rendered image may be output in a hardcopy form such as paper for subsequent display.

### SUMMARY

A pattern based design tool includes a plurality of image building functions for generating visual content on an on-screen rendered area, or canvas, in which the canvas is responsive to graphical manipulations for changing the appearance of an image on the canvas. A plurality of available image building functions and image manipulation functions allow modification of the visual content on the canvas to generate a modified image, such that the canvas accumulates visual content in response to invocation of the image building functions and the image manipulation functions. The image on the canvas is incorporated as a repeated pattern in successive drawing functions, such that an accumulated image defines a repeated portion of the successive applied drawing (image building) functions, and represents a hierarchy of previously entered images to define a sub pattern of entered items on the canvas. In this manner, a repeated pattern defines a sub-element of an entered item without requiring repeated entry of the entire patterned sub-element as with conventional approaches.

In configurations discussed further below, a visual rendering of an image is displayed on a GUI device, such as an iPad®, Android®, Mac/PC or similar handheld, tablet, or desktop computing device. The image is a collection of graphical items such as lines, shapes, and other geometric entities and colors.

In the configuration depicted herein, image building functions add the items to the image, and the image manipulation functions arrange the items, such as rotating, scaling, cropping, transposing, and shading/coloring, for example. The graphical operations include both image manipulation and image building functions.

A canvas is a designated area, or window on the GUI in which the image is rendered during development, and effectively aggregates the result of the image building functions and the image manipulation functions. A pattern is a depiction of the image on the canvas taken at a point in time. The pattern may then be saved and employed in other images as a sub-image. The sub-image is replicated as a sequence in another item, such as a line comprised of a sequence of an image, typically in a reduced scale. Since the patterns may comprise sub-images on another canvas, which may then itself define another pattern, the patterns define a hierarchy in which items in the pattern include other patterns.

Configurations herein are based, in part, on the observation that graphical designs for visual rendering operations often require time consuming, repetitive manipulations of user input commands (keystrokes, pointer movements, or mouse clicks) to define visual elements. Unfortunately, conventional approaches to digital graphical design suffer from the shortcoming that substantial effort and/or artistic ability is required in order to define a graphical image, and certain users may not have sufficient time or artistic ability to adequately create a suitable image with pleasing proportion and symmetry, for example.

Accordingly, configurations herein substantially overcome the above described shortcomings of conventional digital design by providing a method of entering a graphical image through a series of image building functions, such as line and shape entry functions, and incorporating the graphical image as a repeated pattern in a hierarchy of graphical images that employ the graphical image as the foreground of the image building functions. The hierarchy of images is represented in a rendered form on the on-screen visual rendering area provided by the canvas, and may be saved for later incorporation in the hierarchy. The canvas, therefore, may employ image building functions that incorporate a previously entered image as a sub-pattern or subimage in a current image by repeating the subimage in the foreground representation of lines, shapes and other on-screen renderings. For example, an initial image may contain an assortment of lines and shapes, and the initial image scaled and employed in a successive image such that a drawn line includes a repeated pattern of the initial image as a subimage in the foreground of the line (as opposed to a solid black or other foreground color).

A selection of an image manipulation function may be employed to manipulate and modify the entered items to augment the visual appearance. For example, the image manipulation functions may stretch, rotate, or invert shading of the entered items, or may arrange the entered items by selective manipulation to certain quadrants or portions of the canvas area, such as rotating a subset of quadrants while leaving other quadrants unmodified.

Depicted further below is a pattern based design application that includes a plurality of image building functions for generating visual content, such that the canvas is responsive to graphical manipulations for changing the appearance of an image on the canvas, and a plurality of image manipulation functions for modifying the visual content to generate a modified image. The canvas accumulates visual content to depict invocation of the image building functions and the image manipulation functions.

The pattern based design application performs a method of generating a visual image by adding graphical material to a visual rendering of an image, in which the added graphical material includes a repeated pattern of previously rendered graphical material. In an example configuration, the pattern based design application defines the pattern by building a first pattern from at least one graphical operation, in which the graphical operation generates visual content to the pattern, and builds a second pattern from another graphical operation, such that the second pattern adds content by repeated application of the first pattern such that the visual content of the first pattern defines a repeated portion in the second pattern.

In the example configuration, the graphical operations include image building functions for generating visual content, and image manipulation functions for modifying the visual content, for adding and manipulating the rendered items on the canvas, respectively. The image building functions therefore add visual graphical material to an image via the canvas, and the manipulation functions modify the rendering in the canvas by reorganizing material already rendered.

In a particular arrangement, the first and second patterns define successive levels in a hierarchy of patterns, such that each level in the hierarchy includes a repeated sequence of the patterns in a previous level of the hierarchy. The successive (higher) levels therefore replicate patterns from lower levels in a sequence to form lines, shapes, solids and other geometric renderings using the lower level patterns.

From a user interface perspective, the visual images are therefore generated as graphical designs by selecting an image building function for adding visual content on a canvas, in which the canvas is responsive to graphical manipulations for changing the appearance of an image on the canvas, and selecting an image manipulation function for modifying the visual content on the canvas to generate a modified image. A user repeats selection of the image building functions and the image manipulation functions in an iterative manner to accumulate an aggregate image based on successive modified images, by adding successive items to the canvas. Once a particular aggregate image is completed on the canvas, the image may be saved as a pattern, such that the aggregate image is selected and employed by the user as an element of an image building function in a successive image. A plurality of the aggregate images may be saved in a repository of selectable images.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of a an environment suitable for use with generating and disseminating graphical designs according to configurations herein;

FIG. 2 is a diagram of graphical design generation on a personal computing device in the environment of FIG. 1;

FIG. 3 is a flowchart of graphical design generation using the computing device of FIG. 2;

FIG. 4 is a display screen of a computer application for generating graphical designs according to the method of FIG. 3;

FIG. 5 is an example of a design using the application of FIG. 4;

FIG. 6 shows a color selection screen for color selection in the application of FIG. 4 using image building functions; and

FIG. 7 shows the design of FIG. 5 as a subimage in a larger design using image building functions;

FIG. 8 shows the design of FIG. 5 modified using an image manipulation function;

FIG. 9 shows another design similar to FIG. 5;

FIG. 10 shows a trace line of the design of FIG. 9;

FIG. 11 shows a design using the design of FIG. 9 as a subimage;

FIG. 12 shows a design using a repeating quadrant of the design of FIG. 9;

FIG. 13 shows the design of FIG. 9 using a repeating row function;

FIG. 14 shows the design of FIG. 9 using repeating columns;

FIG. 15 shows the design of FIG. 9 using a matrix function;

FIG. 16 shows the design of FIG. 9 using a column rotation function;

FIG. 17 shows a shape function and fill using the designs of FIGS. 9 and 11; and

FIG. 18 shows a pattern line using the design of FIG. 11.

### DETAILED DESCRIPTION

The examples discussed below depict an example implementation of a graphical user interface (GUI) for performing the disclosed methods. Example GUI controls, such as buttons, checkboxes and sliders, are shown for receiving input through the user device, via suitable input mechanisms such as pointing devices and keyboards. Alternate approaches may employ alternate arrangements of the GUI controls; emphasis is on the computation and rendering features disclosed. The disclosed system provides a user interface responsive to a variety of functions and graphical operations, including image building functions and image manipulating functions, as depicted below, and are invokable in a plurality of sequences depending on user direction. The approach disclosed below demonstrates an example invocation of the various graphical operations for illustrating the principles and methods of the proposed approach; other selections and sequences of the graphical operations may be performed.

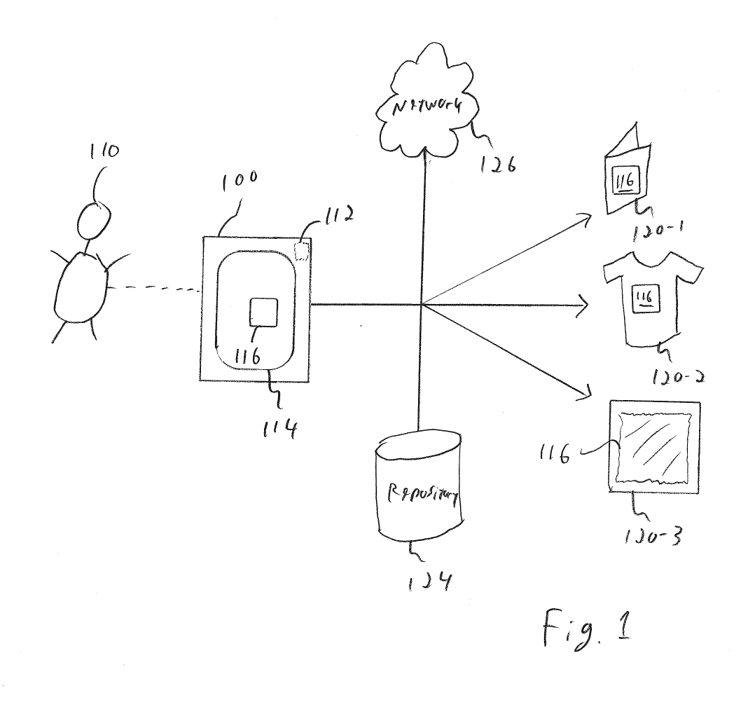

FIG. 1 is a context diagram of an environment suitable for use with generating and disseminating graphical designs according to configurations herein. Referring to FIG. 1, a personal computing device 100 is responsive to a user 110 for executing a design application 112 (app). The personal computing device 100 may be any suitable microprocessor appliance, such as a tablet, smartphone, laptop (e.g. iPad®, iPhone®) or other suitable portable or desktop computing device. The app 112 executes (launches) on the device 100 for interacting with the user 110 for creating and generating a design 116 on a rendering area 114 of the device, typically a display screen such as an LED or LCD display. The design 116 is a visible, aesthetic rendering expressed as a pixelated image, and may be output, transmitted, or printed/displayed on a suitable hardcopy rendering medium, such as a printer. The generated designs 116 may be employed in physical form on items such as books and cards 120-1, textile and clothing prints 120-2, and file based hardcopy or solid rendering, including advertising media such as posters, brochures, and signage 120-3 (120 generally). Any suitable rendering and/or manufacturing format may be the destination of the physically rendered design, depending on the output file format and available rendering equipment 120. For example, apparatus for designing on wood, plastics and other materials that involve CNC machinery, water-jet cutting, laser cutting, and garment printers. The application 112 employs corresponding drivers and output files for generating device specific output file formats that are employed for creating patterns on various surfaces, The designs 116 may also be transported and stored as digital files on a disk or non-volatile media such as repository 124, or transported by a public access network 126 such as the Internet, for transfer, media posting, or subsequent rendering.

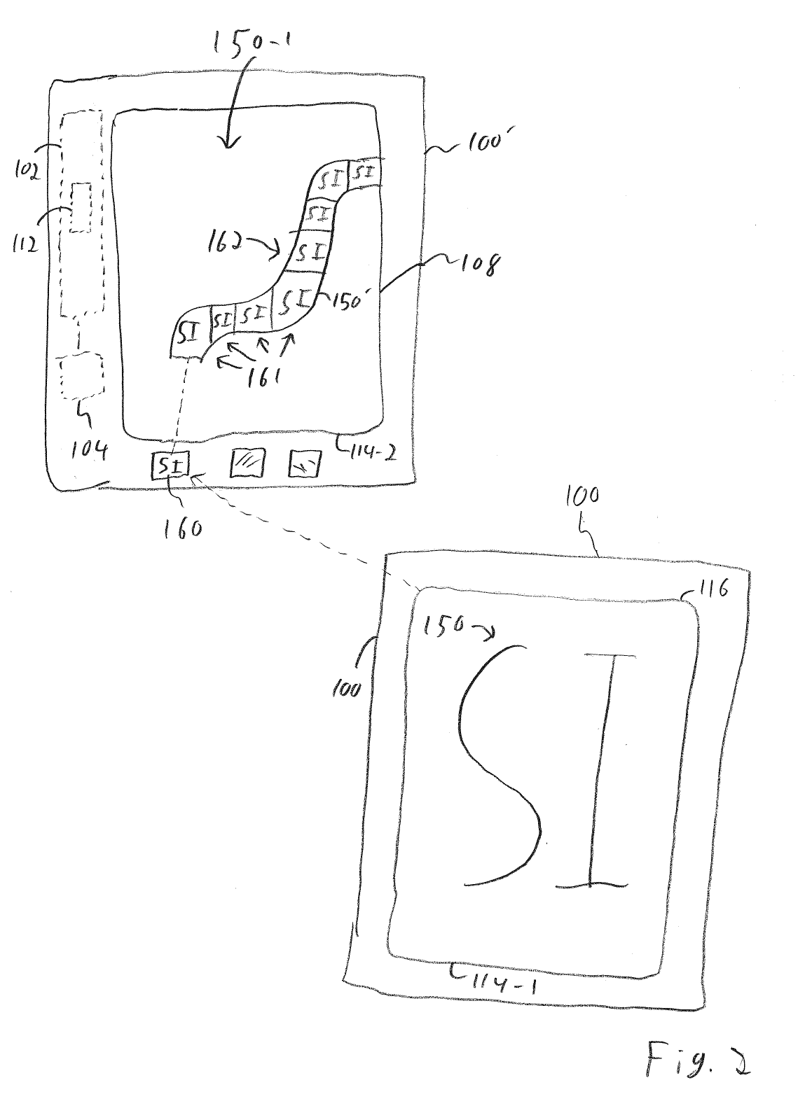

FIG. 2 is a diagram of graphical design generation on a personal computing device in the environment of FIG. 1. Referring to FIGS. 1 and 2, the app 112 executes on the computing device 100 and interacts with the user via the rendering area 114-1, or screen, and receives input via a pointer device mechanism, which may be a touchscreen feature of the device 100 or a mouse, touchpad, or keyboard, as is typical with such devices. The app 112 executes in a memory 102 of the device 100, and is responsive to a processor 104 for receiving input and display/rendering output, also typical of such devices.

In the example shown, the application 112 is employed to create an initial image 150, shown in the rendering area 114-1. The initial image 150 defines a subimage 150′ (shown as “SI”) in a subsequent rendering 114-2, rendering another image 150-1. In operation, a pattern icon 160 defines the stored rendering area 114-1 as a pattern, and a subsequent drawing operation invokes the subimage 150′ as an element 161 in a pattern line 162, such that the line is comprised of consecutive renderings of the subimage 150′, rather than a solid black or other color. In other words, in common drawing applications employing a “pen” operation, the subimage 150′ defines the pen color, rather than another solid color or pattern. The line elements 161 are therefore taken from other images, rather than from predetermined solids or fill sequences. As will be discussed further below, a variety of drawing tools are available, and the new image 150-1 can itself be stored and referenced as a subimage 150′ in subsequent designs. A library or repository 124 of stored patterns may be referenced and invoked as subimages 150′ in a current image 150-1.

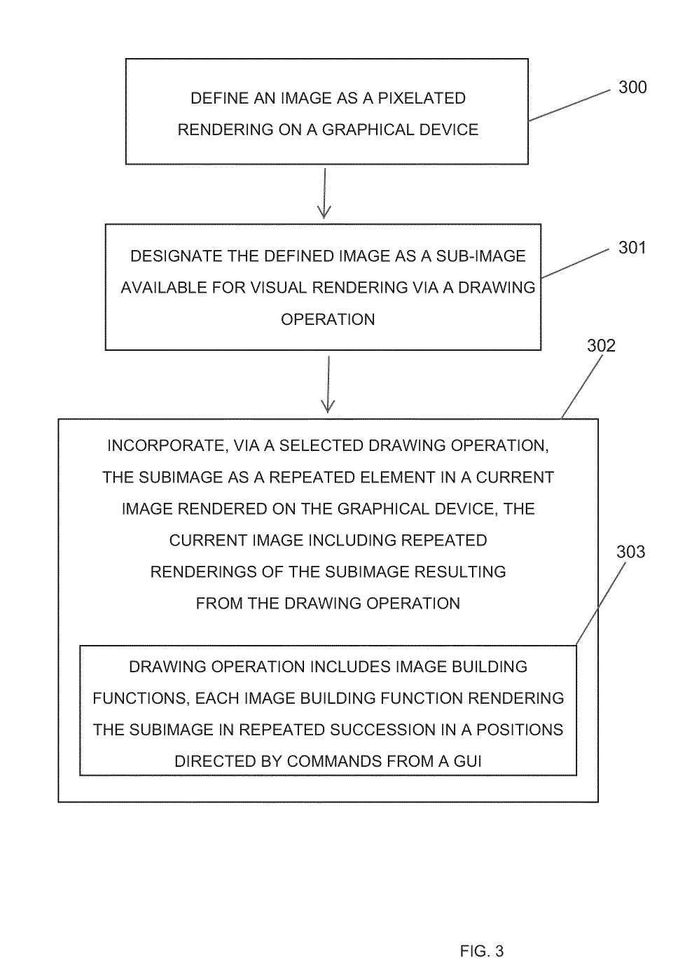

FIG. 3 is a flowchart of graphical design generation using the computing device of FIG. 2. Referring to FIGS. 1-3, the method for graphical design rendering as disclosed herein includes, at step 300, defining an image 150 as a pixelated rendering on the graphical device 100, and designating the defined image 150 as a sub-image 150′ available for visual rendering via a drawing operation, as depicted at step 301. A selected drawing operation incorporates the subimage 150′ as a repeated element in a current image 150 rendered on the graphical device 100, such that the current image includes repeated renderings of the subimage 150′ resulting from the drawing operation, as shown at step 302. In the example arrangement, therefore, the drawing operation includes image building functions, such that each image building function renders the subimage in repeated succession in a positions directed by commands from a GUI (Graphical User Interface), as depicted at step 303. The subimage 150′ defines the pen or brush employed for rendering the (now primary 150) image, just as conventional pen or brush drawing operations employ a solid black or other color. The drawing operation iteratively repeats the inclusion of an image 150 as a sub-image 150′, such that the current image becomes the subimage rendered as the repeated element in a successive current image. The resulting line appears as a concatenation of the subimage (at a reduced size) as if it was a foreground color rendered by the drawing operation.

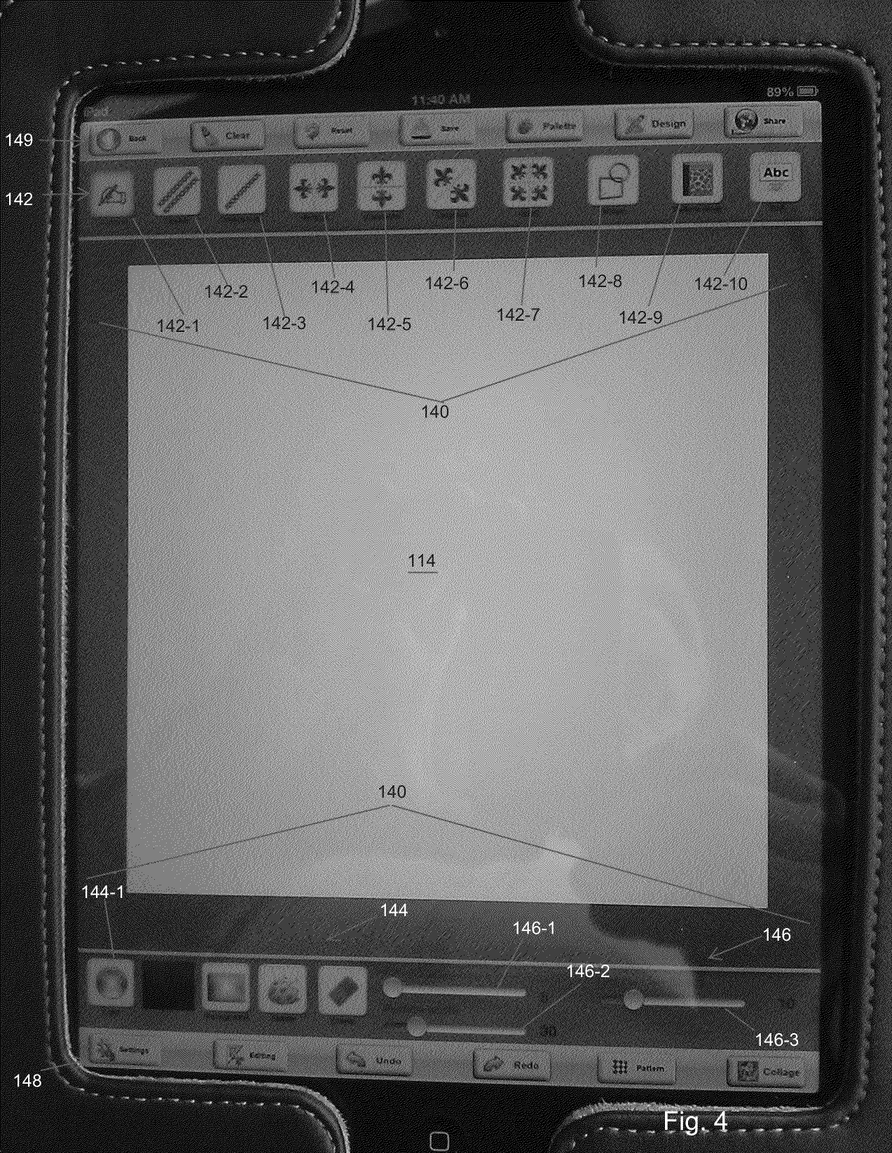

FIG. 4 is a display screen of the computer application 112 for generating graphical designs 116 according to the method of FIG. 3. Referring to FIGS. 2 and 4, the device 100 has a visual display screen 108 including the rendering area 114-1 . . . 114-2 (114 generally) for displaying the current image 150, and for displaying controls 140 in a perimeter or margin area around the rendering area 114, sometimes referred to as a canvas, to denote the aesthetic nature of the rendered images 150. The controls 140 allow invocation of image building functions and image manipulation functions for applying to the image 150 in the rendering area. Drawing tools 142 perform addition of specific visual elements, such as lines and shapes, and allow for manipulating those shapes. Drawing medium controls 144 define current colors and direction of the drawing tools 142, such as background and color palette selections. Drawing settings 146 control parameters of the drawing tools 146, such as line weight, pattern scale and transparency. Edit controls 148 direct the commands entered, such as undo/redo and toggling edit modes, and administrative controls 149 control the rendering area 114 by saving and recalling images 150 from storage.

A plurality of drawing operations are available, generally defining image building functions, which add graphic material to the image 150, and image manipulation functions, which augment or duplicate graphic material already a part of the image 150. In the example configuration, therefore, the drawing operations includes a suite of image manipulation function, each operable for receiving an identity of an element, typically via a pointer (mouse) click, in which the element is a previously rendered portion of the current image. The selected element, or portion of the image 150, is rendering the identified element in a different location, often after duplication according to a symmetry line or quadrant arrangement.

In FIG. 4, a pen or brush function 142-1 draws a solid line, a single pattern line 142-2 draws a single width line of a pattern, similar to FIG. 2, and a double pattern line 142-3 draws parallel renderings of pattern lines. Slider 146-1 controls the width of the pen/brush function 142-1, and slider 142-2 controls the pattern width. Slider 146-3 determines the width between the patent lines in the double pattern line function 142-3. A current pattern is selected for use as a subimage 150′ from previously stored patterns using design button 149-1.

Image manipulation buttons 142-4 . . . 142-7 perform split and quadrant functions that subdivide the canvas 114 along horizontal, vertical, diagonal, or quadrant lines and replicate the current design in each split. Shape button 142-8 allows selection of predetermined geometric shapes. Previously entered designs 116 are stored and selectable via a pattern book 142-9, and text entry is facilitated via a typewriter buttons 142-10.

The graphical device 100 renders foreground segments and background areas, such that the image building functions are configured to render the elements in the current image 150 as the foreground segments visually rendered over the background areas, and the background areas remaining visually unchanged until obscured by the foreground segments. The drawing operations overwrite a previously rendered foreground segment with a successively rendered foreground segment, such that the successively rendered foreground segment defines the visual appearance. As the visual rendering includes displaying the image 150 on a pixel based device 100, the drawing operations shift pixel colors of the rendered foreground segments from that of the background areas using the image manipulation functions, based on the pen location and subimage 150′. The rendered the elements include lines, shapes, boxes, areas, or any geometric arrangement as defined by the subimage 150′ and according to a selected image building function.

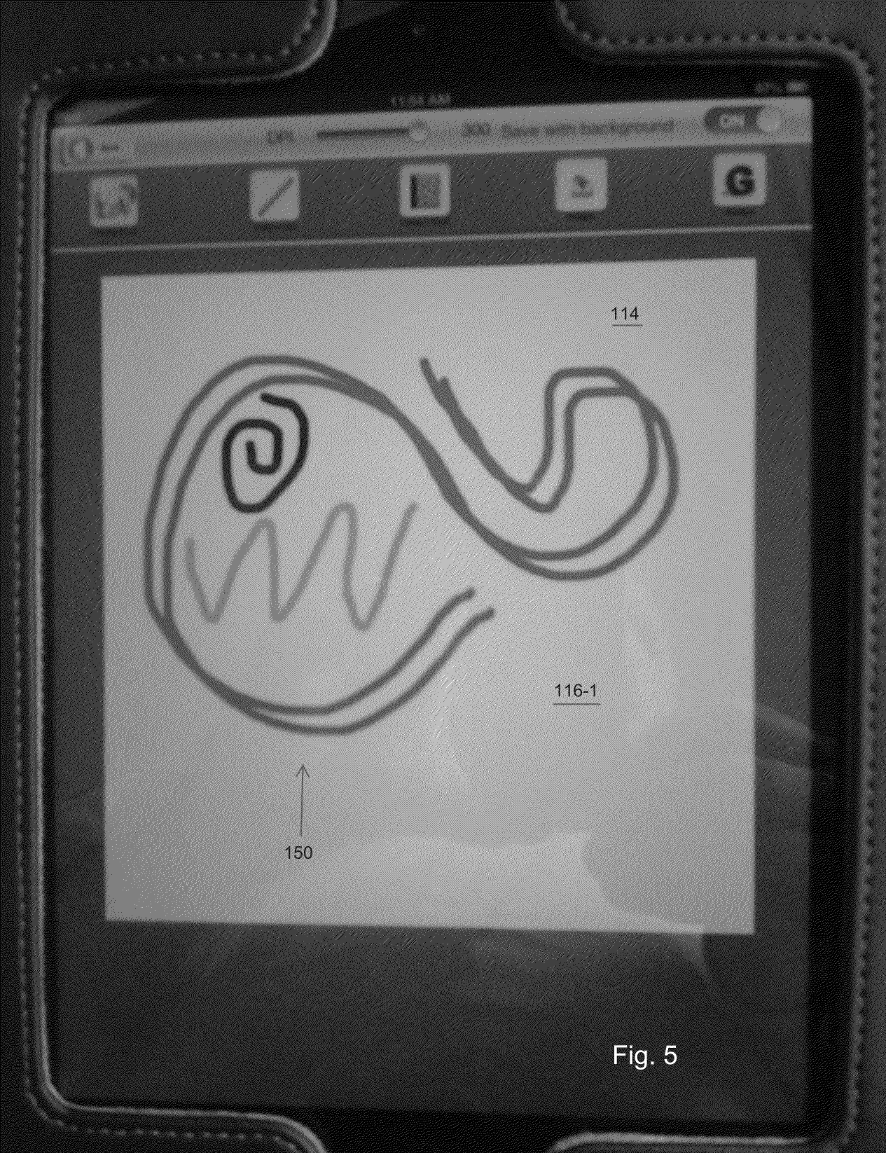

FIG. 5 is an example of a design using the application of FIG. 4. FIG. 5 shows an arbitrary design 116-1 from application of the pen function 142-1. Alternatively, a design 116 may emanate from photographic input, imported from other drawing tools, or saved designs 116 previously developed using the application 112.

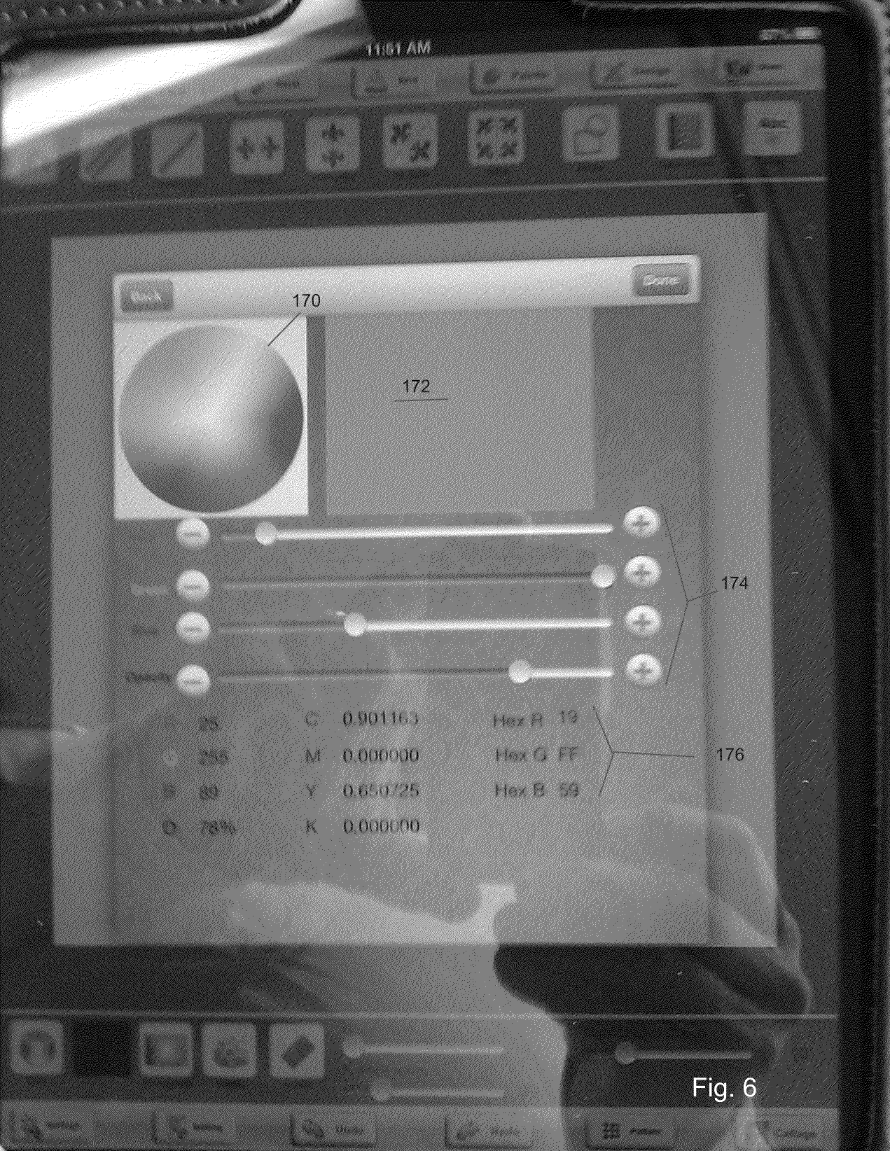

FIG. 6 shows a color selection screen for color selection in the application of FIG. 4 using the drawing medium button 144-1. A color wheel 170 allows visual selection of color and saturation. A sample window 172 shows the currently selected color. Hue selection sliders 174 allow varying intensity of different color elements, such as red, green and blue elements to further refine the hue, saturation and intensity. Color value displays 176 show numeric values for each of the color elements. Generally, a user begins color selection using the color wheel 170, to set initial values for the values shown in the color value displays 176, and then “fine tunes” the values using the hue selection sliders 174.

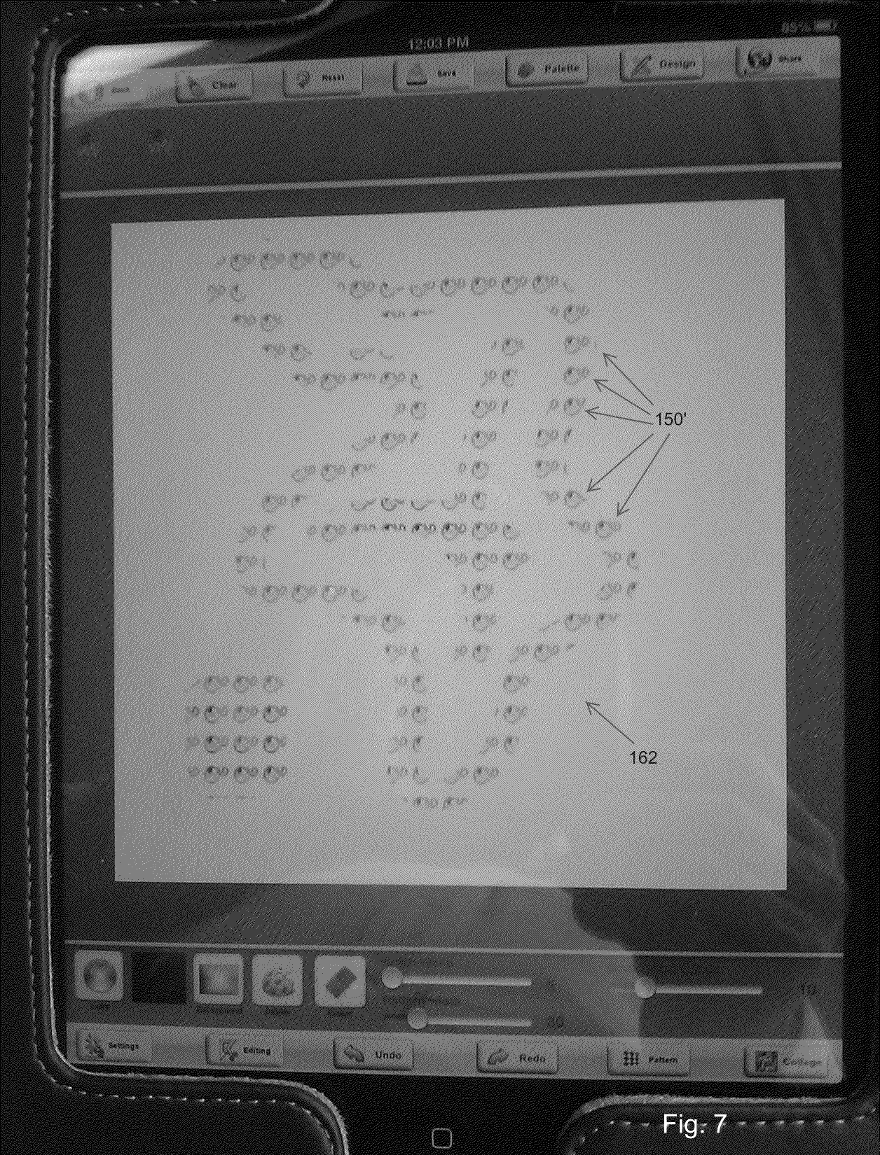

FIG. 7 shows the design 116-1 of FIG. 5 as a subimage in a larger design using image building functions. Referring to FIGS. 1, 5 and 7, the image 116-1 is rendered as a subimage 150′ by forming elements 161 of a pattern line 162, drawn using the single pattern line button 142-3. FIG. 7 further illustrates the hierarchy of designs depicted by the subimage 150′, included as an element 161 of a larger primary or current image 150, which may span a plurality of levels. Thus, a user may continue to build successive images 150 using one or more subimages 150′ previously generated. In this manner, the disclosed approach presents method of generating a visual image 150, by employing the GUI for adding graphical material to a visual rendering of an image 150, in which the added graphical material includes a repeated pattern of previously rendered graphical material, shown as subimage 150′, which may be any previously developed design 116.

The pattern (design 116) development further includes building a first pattern from one or more of the graphical operation (image building and generating functions), such that the graphical operation generates visual content in the pattern. The first pattern becomes the subimage 150′. The user 110 builds a second pattern from another graphical operation, in which the second pattern adds content by repeated application of the first pattern such that the visual content of the first pattern defines a repeated portion in the second pattern. The second pattern is the current or primary image 150 because it is incorporating other (i.e. the first pattern) patterns as elements 161.

Upon repeated application of images 150 and subimages 150-1, the first and second patterns may define successive levels in a hierarchy of patterns, such that each level in the hierarchy includes a repeated sequence of at least one of the patterns in the previous level of the hierarchy. The graphical operations invoked may include the image building functions for generating visual content, and image manipulation functions for modifying the visual content, as described above.

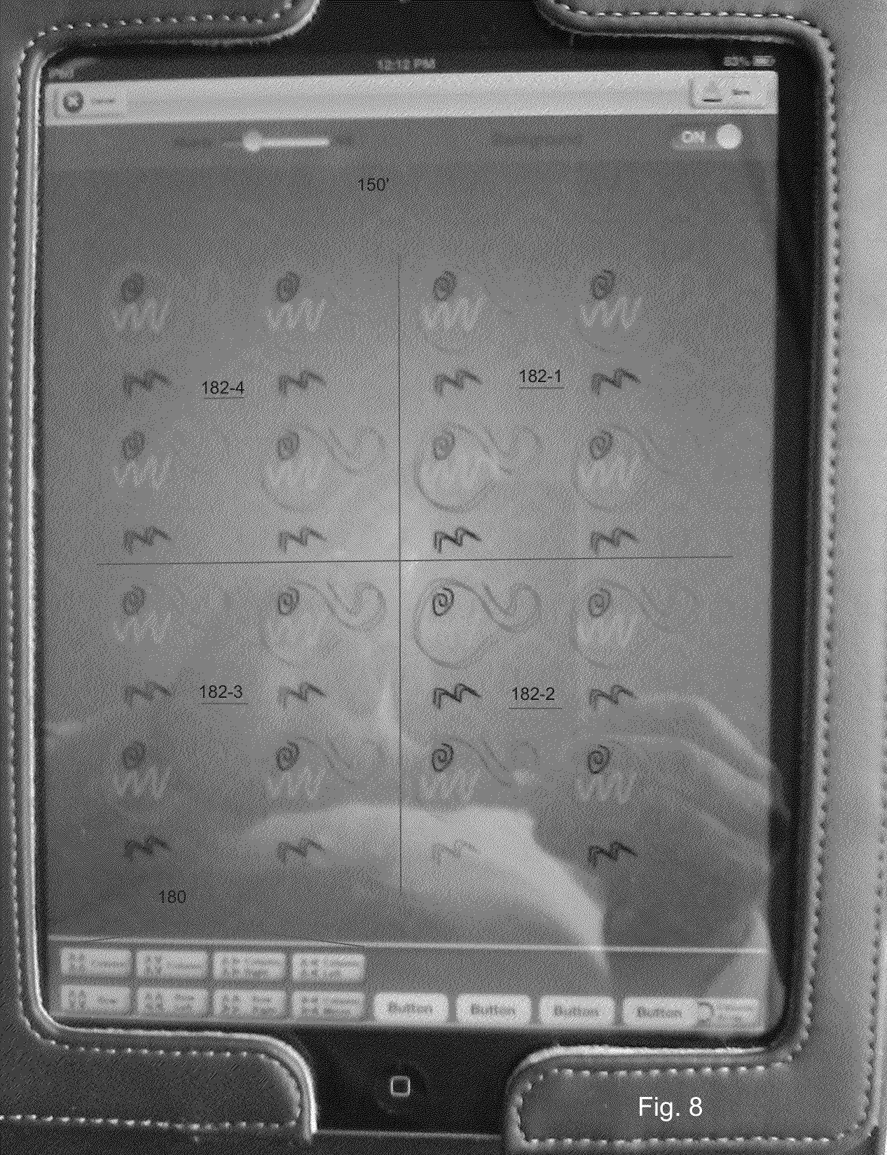

FIG. 8 shows the design of FIG. 5 modified using an example image manipulation function. Referring to FIGS. 5 and 8, a quadrant function is operable to subdivide the image 150 into quadrants, such that each area of the quadrant includes a duplication of the design 116-1. The depicted rendering includes a 4*4 arrangement of the subimage 150,′ which may further be subdivided into additional quadrants 182-1 . . . 182-4 (182 generally). A plurality of quadrant functions 180 provide selective rotation of a subset of the quadrants 180.

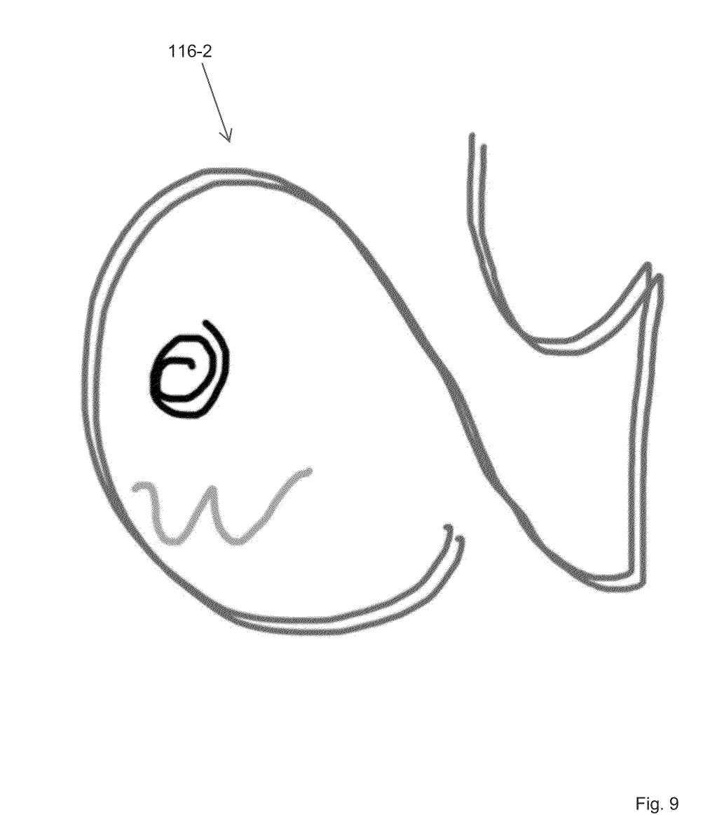

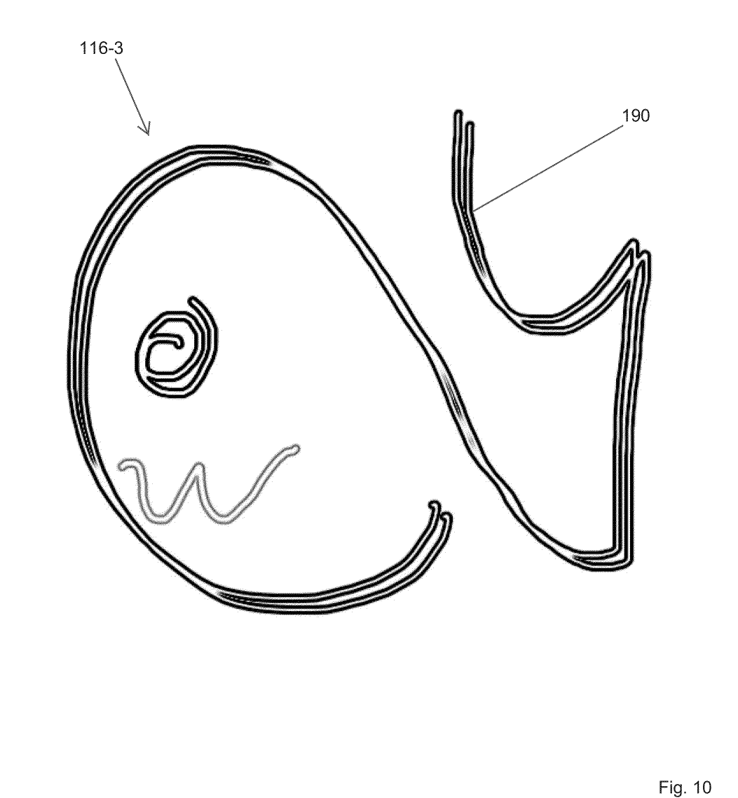

FIG. 9 shows another design similar to FIG. 5. Referring to FIGS. 9 and 10, FIG. 10 shows a trace line operation 190 and rendering 116-2 of the design of FIG. 9.

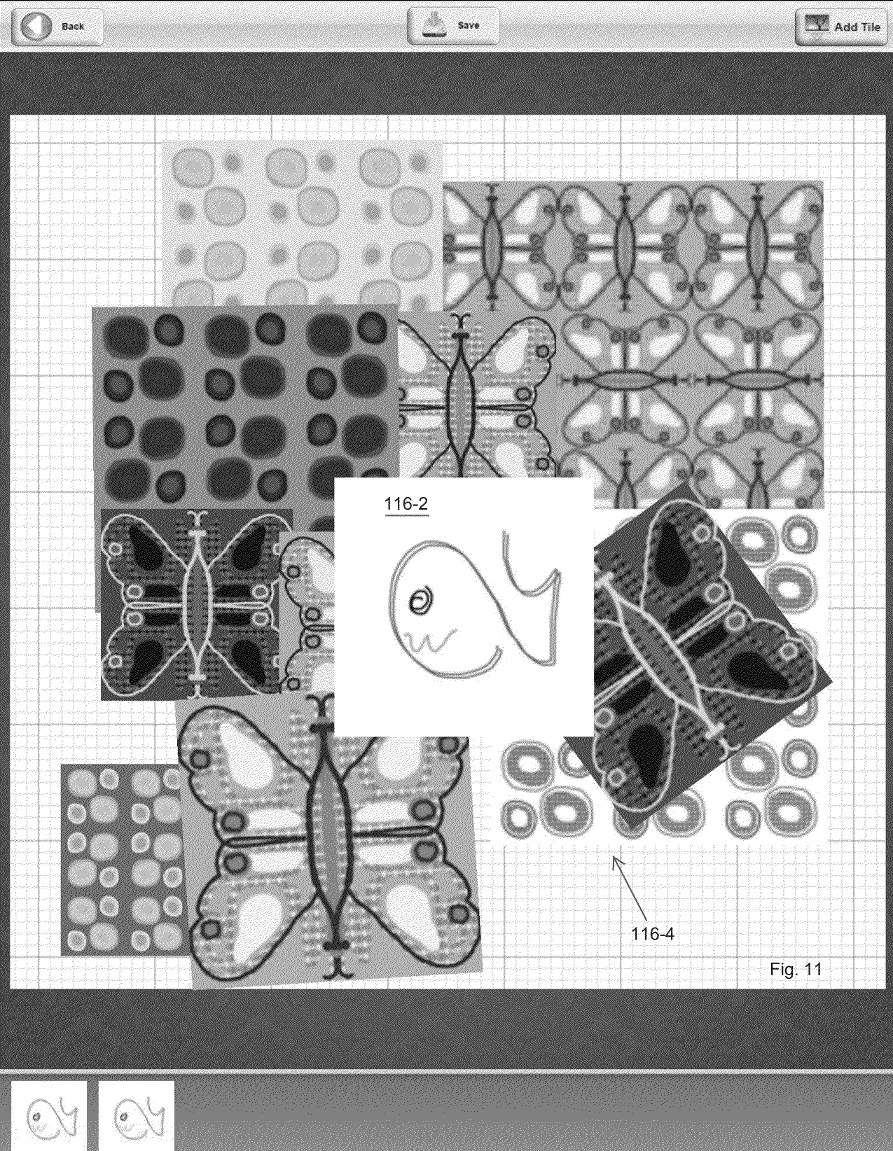

FIG. 11 shows a design 116-4 using the design 116-2 of FIG. 9 as a subimage, illustrating the hierarchy of designs. Design selection icons 145 are invoked to select previously stored designs 116 as the pen or brush for rendering. The remainder of design 116-4 includes a collage of other designs 116, also stored as individual designs

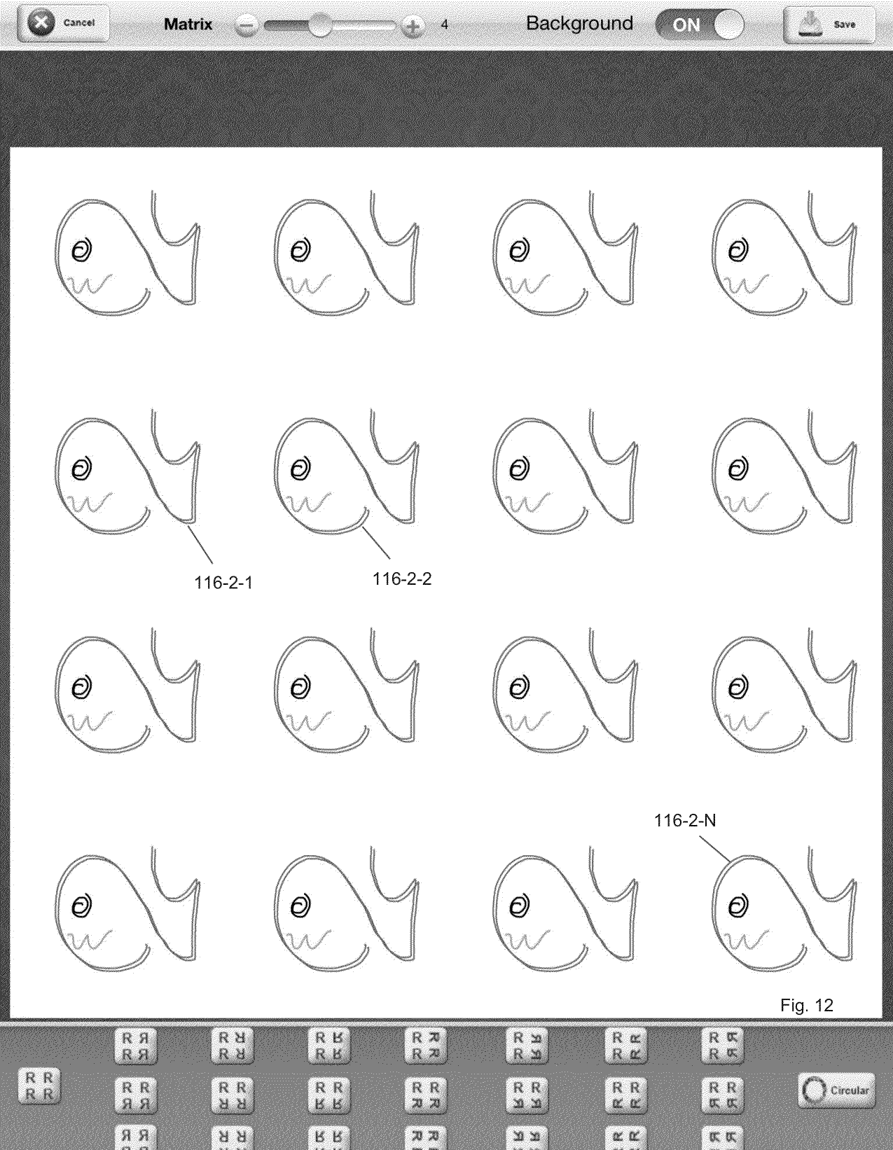

FIG. 12 shows a design using a repeating quadrant of the design of FIG. 9. Referring to FIG. 12, a base image, 116-2 shown, is replicated in a row and column format, similar to FIG. 8. Images 116-2-1 . . . 116-2-N, in general (a 4*4 rendering of N=16 instances is shown). Various image manipulation functions are invokable on the base image 116-2, as shown in the following Figures.

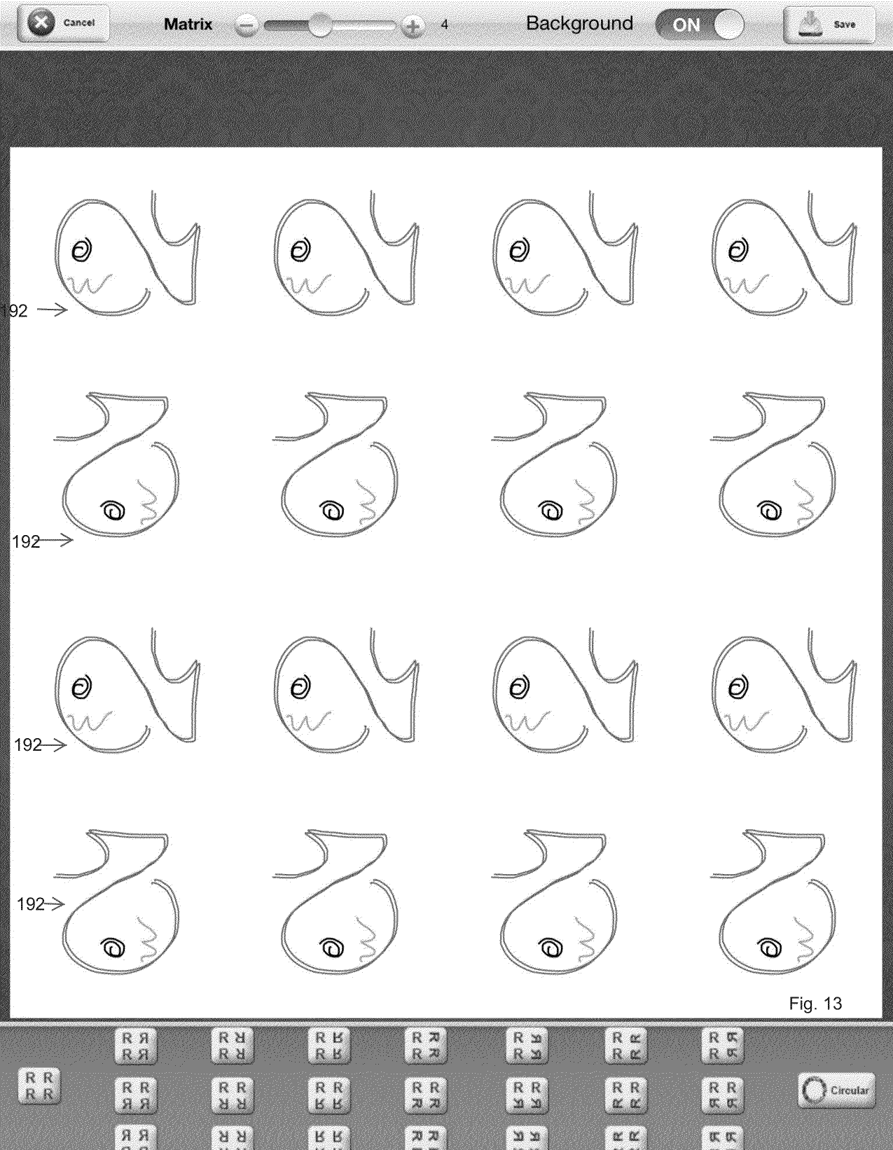

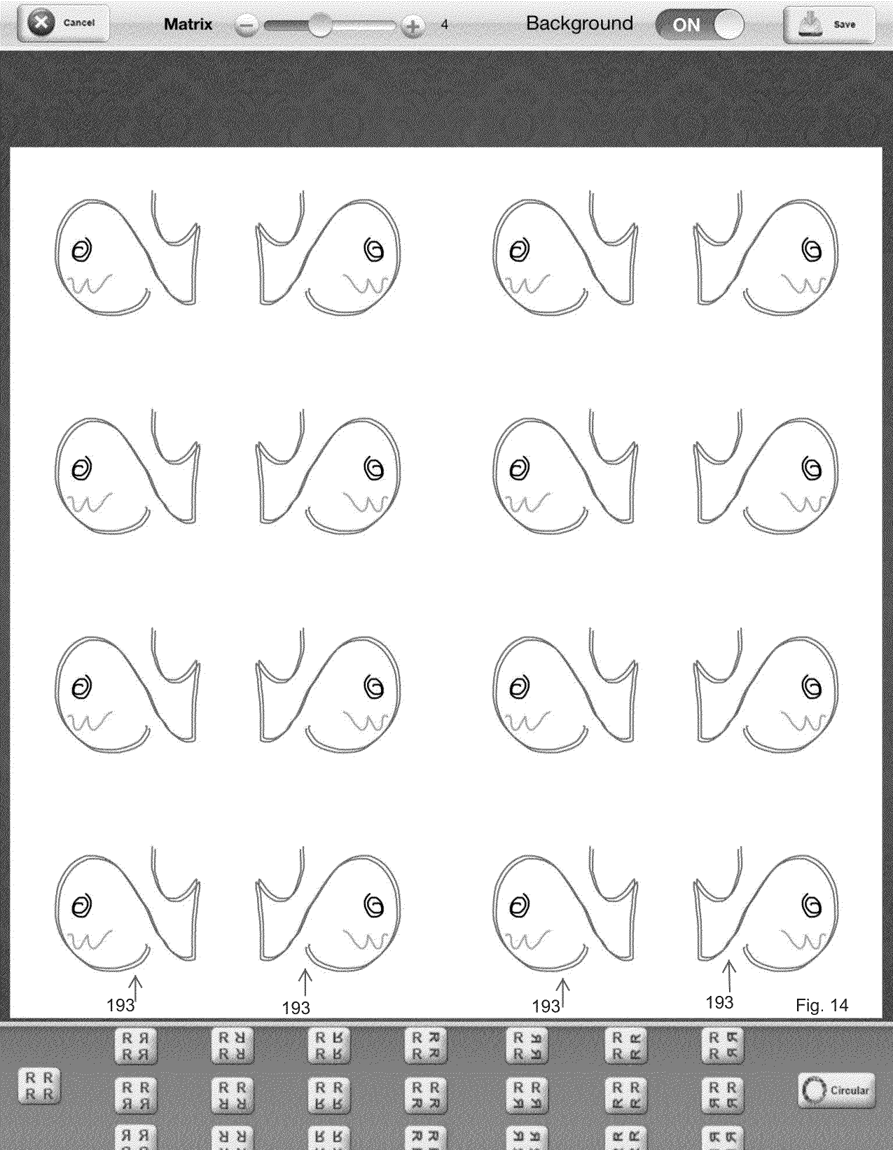

FIG. 13 shows the design of FIG. 9 using a repeating row function. Referring to FIG. 13, each row 192 has a common orientation, shown alternating from 0 degrees to rotated left 90 degrees. FIG. 14 shows the design of FIG. 9 using repeating columns. In

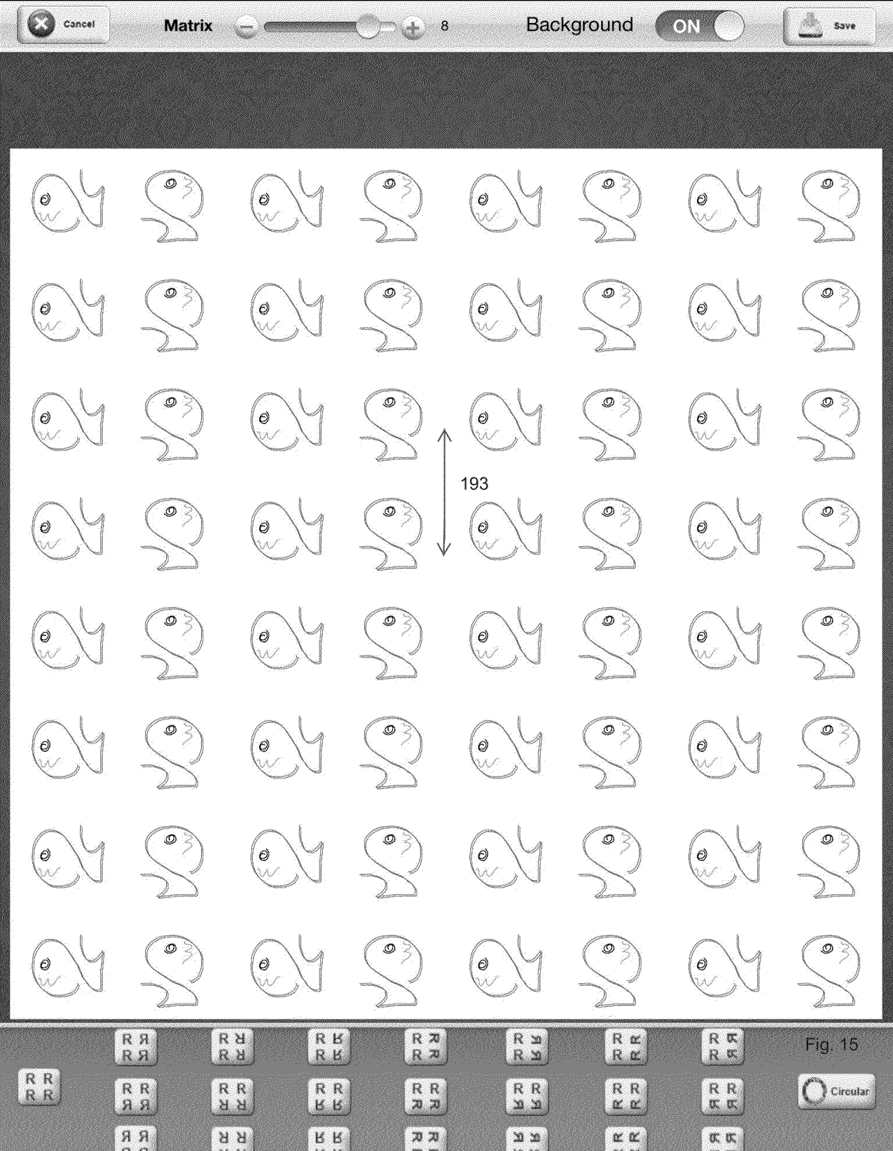

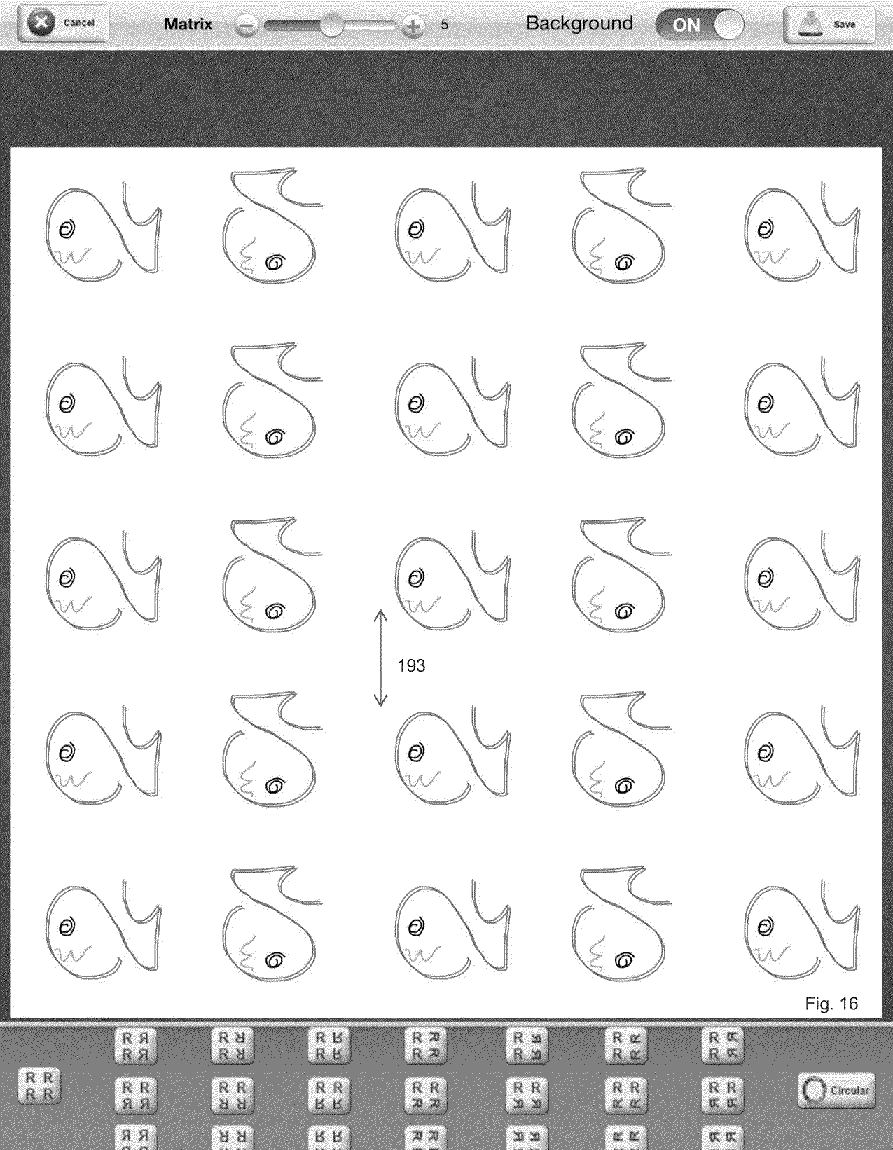

FIG. 14, each column 193 shares a common orientation, shown alternating rotation of 180 degrees. FIG. 15 shows the design of FIG. 9 using a matrix function, such that an arbitrary M*N matrix of image 116-2 renderings is performed, shown as an 8*8 matrix alternating by column. 193. FIG. 16 shows the design of FIG. 9 using a column 193 rotation function, such that each column 193 is rotated.

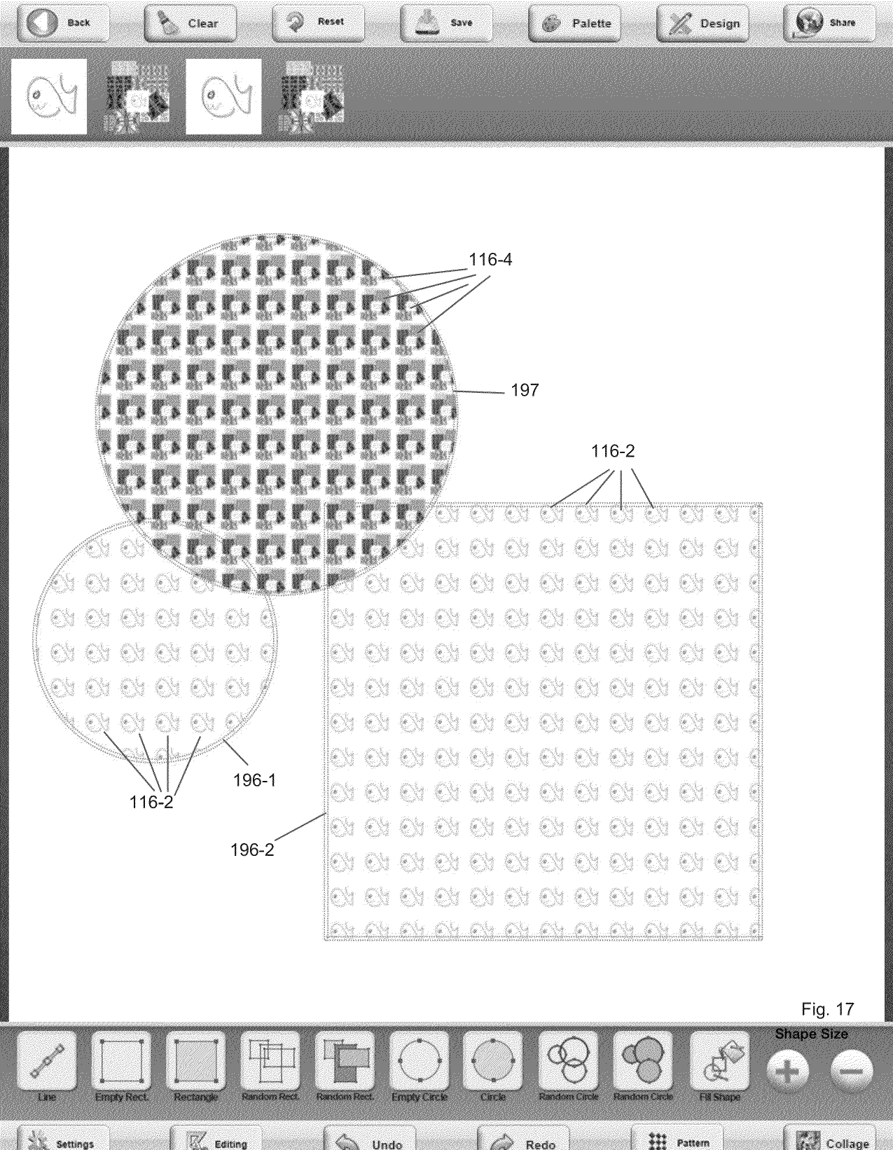

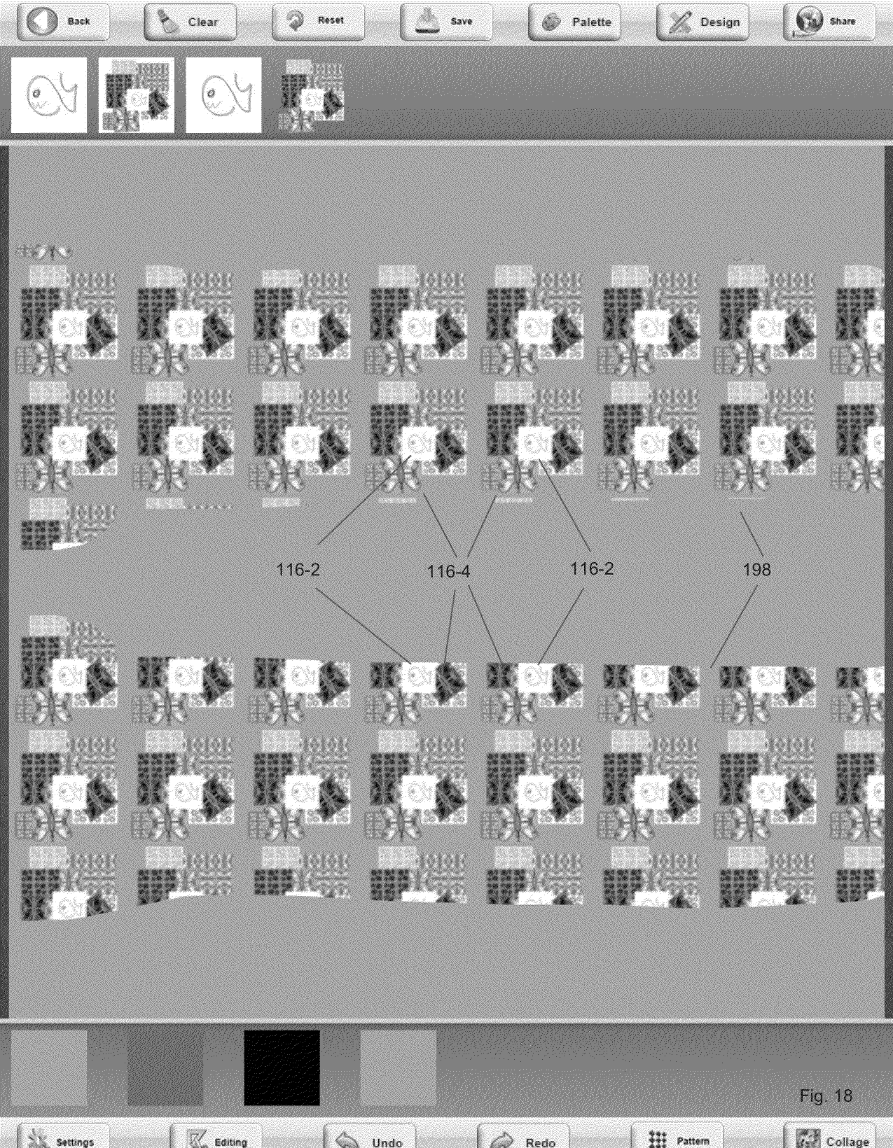

The image manipulation functions may be compounded and aggregated, as disclosed above. FIG. 17 shows a shape function and fill using the designs of FIGS. 9 and 11. Referring to FIGS. 4, 9 and 11, the shapes function 142-8 draws shapes 196-1 and 196-2 using image 116-2 as the fill pattern, and shape 197 using image 116-4 as the fill pattern. Note further that image 116-4 also includes a rendering of image 116-2, showing the nested or hierarchical capability. FIG. 18 shows a pattern line using the design of FIG. 11. In a similar manner, a double pattern line 198 (occupying almost the entire canvas, or rendering area 114) employs image 116-4 as the drawing medium, which incorporates image 116-2.

The physical form of the disclosed approach may take the form of pattern based design tool, operable on a computing device 100, including a plurality of image building functions for generating visual content, the canvas responsive to graphical manipulations for changing the appearance of an image on the canvas, and a plurality of image manipulation functions for modifying the visual content to generate a modified image. A rendering area 114 on the design tool defines a canvas for accumulating visual content configured to depict invocation of the image building functions and the image manipulation functions.

Referring again to FIGS. 1 and 2, the design tool may be implemented by an application (app) 112 operative for launch and execution on the computing device. The app 112 is configured for selecting an image building function for adding visual content on a canvas, in which the canvas is responsive to graphical manipulations for changing the appearance of an image 150 on the canvas. The user 110 selects an image manipulation function for modifying the visual content on the canvas to generate a modified image 150. The app 112 allows repetitive or iterative selection of the image building functions and the image manipulation functions to accumulate an aggregate image based on successive modified images. The image building and manipulation functions allow selection the aggregate image and employing the aggregate image (subimage 150′) as an element of an image building function in a successive image 150. The app 112 performs saving of the aggregate image in a repository 124 of selectable images, and successive recall, such that subsequently invoked building functions add visual graphical material to an image via the canvas. The image manipulation functions may also be invoked, in any suitable order, for modify the rendering in the canvas by reorganizing material already rendered.

The user device as disclosed herein refers to any suitable portable or stationary computing device, such as handheld devices commonly known as smartphones, tablets, notebooks, PDA (Personal Digital Assistant), and laptops, as well as desktop computers, characterized by a user display or visual rendering area, user input facilities such as keypads (often rendered on the display), pointing devices such as a mouse, touchpad, trackball, or pointer, and a memory/processor configuration for launching and executing applications (apps) including instructions for receiving input from the user and rendering results sought by the user. Such various computing facilities suitable for use with configurations herein may be employed for providing the system, methods and apparatus described.

Those skilled in the art should readily appreciate that the programs and methods defined herein are deliverable to a user processing and rendering device in many forms, including but not limited to a) information permanently stored on non-writeable storage media such as ROM devices, b) information alterably stored on writeable non-transitory storage media such as floppy disks, magnetic tapes, CDs, RAM devices, and other magnetic and optical media, or c) information conveyed to a computer through communication media, as in an electronic network such as the Internet or telephone modem lines. The operations and methods may be implemented in a software executable object or as a set of encoded instructions for execution by a processor responsive to the instructions. Alternatively, the operations and methods disclosed herein may be embodied in whole or in part using hardware components, such as Application Specific Integrated Circuits (ASICs), Field Programmable Gate Arrays (FPGAs), state machines, controllers or other hardware components or devices, or a combination of hardware, software, and firmware components.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A method for graphical design rendering, comprising:
defining an image as a pixelated rendering on a graphical device;
designating the defined image as a sub-image available for visual rendering via a drawing operation; and
incorporating, via a selected drawing operation, the subimage as a repeated element in a current image rendered on the graphical device, the current image including repeated renderings of the subimage resulting from the drawing operation.

2. The method of claim 1 wherein the drawing operation includes image building functions, each image building function rendering the subimage in repeated succession in a positions directed by commands from a GUI (Graphical User Interface).

3. The method of claim 2 wherein the drawing operation includes an image manipulation function, the image manipulation function:
receiving an identity of an element, the element being a previously rendered portion of the current image; and
rendering the identified element in a different location.

4. The method of claim 1 further comprising iteratively repeating the inclusion of the current image as a sub-image, such that the current image becomes the subimage rendered as the repeated element in a successive current image.

5. The method of claim 2 wherein the graphical device renders foreground segments and background areas, the image building functions configured to render the elements in the current image as the foreground segments visually rendered over the background areas, the background areas remaining visually unchanged until obscured by the foreground segments.

6. The method of claim 5 wherein the drawing operation is configured for overwriting a previously rendered foreground segment with a successively rendered foreground segment, the successively rendered foreground segment defining the visual appearance.

7. The method of claim 5 wherein the drawing operation is configured for shifting the rendered foreground segments and background areas using the image manipulation functions.

8. The method of claim 3 wherein the elements include lines, shapes, boxes, and areas according to a selected image building function.

9. The method of claim 8 wherein visual rendering includes displaying a pixelated image on a pixel based device.

10. A method of generating a visual image, comprising:
adding graphical material to a visual rendering of an image, the added graphical material including a repeated pattern of previously rendered graphical material, defining the pattern further comprising:
building a first pattern from at least one graphical operation, the graphical operation generating visual content in the pattern; and
building a second pattern from another graphical operation, the second pattern adding content by repeated application of the first pattern such that the visual content of the first pattern defines a repeated portion in the second pattern.

11. The method of claim 10 wherein the first and second patterns further comprise successive levels in a hierarchy of patterns, each level in the hierarchy including a repeated sequence of at least one of the patterns in the previous level of the hierarchy.

12. The method of claim 11 wherein the graphical operations include image building functions for generating visual content, and image manipulation functions for modifying the visual content.

13. A pattern based design tool comprising:
a plurality of image building functions for generating visual content, the canvas responsive to graphical manipulations for changing the appearance of an image on the canvas,
a plurality of image manipulation functions for modifying the visual content to generate a modified image; and
a canvas for accumulating visual content configured to depict invocation of the image building functions and the image manipulation functions.

14. The design tool of claim 13 wherein the image building functions are configured for rendering the image as a subimage in repeated succession in a positions directed by commands from a GUI (Graphical User Interface).

15. The design tool of claim 13 wherein the image building functions are configured for iteratively repeating the inclusion of the image as a subimage, such that the image becomes the subimage rendered as the repeated element in a successive current image.

16. The design tool of claim 15 wherein the image and subimage further comprise successive levels in a hierarchy of patterns, each level in the hierarchy including a repeated sequence of at least one of the patterns in the previous level of the hierarchy.

17. A computer program product on a non-transitory computer readable storage medium having instructions for performing a method for generating graphical designs, comprising:
selecting an image building function for adding visual content on a canvas, the canvas responsive to graphical manipulations for changing the appearance of an image on the canvas;
selecting an image manipulation function for modifying the visual content on the canvas to generate a modified image;
repeating selection of the image building functions and the image manipulation functions to accumulate an aggregate image based on successive modified images; and
selecting the aggregate image and employing the aggregate image as an element of an image building function in a successive image.

18. The computer program of method of claim 17 wherein the method further comprises saving the aggregate image in a repository of selectable images.

19. The computer program of method of claim 18 wherein the building functions add visual graphical material to an image via the canvas.

20. The computer program of method of claim 19 wherein the manipulation functions modify the rendering in the canvas by reorganizing material already rendered.
